(19) United States
(12) Patent Application Publication
(10) Pub. No.: US 2019/0007999 A1
(43) Pub. Date: Jan. 3, 2019

(54) METAL HEATING SLEEVE PIPE AND REPLACER THEREOF

(71) Applicant: Dong guan Hotmodo heater Co.,Ltd, Dongguan (CN)

(72) Inventor: Wen Xiao Cao, Guangdong (CN)

(73) Assignee: Dong guan Hotmodo heater Co.,Ltd, Dongguan (CN)

(21) Appl. No.: 15/924,301

(22) Filed: Mar. 19, 2018

(30) Foreign Application Priority Data
Jun. 30, 2017 (CN) 201710522801.8

(51) Int. Cl. H05B 3/42

(52) U.S. Cl. CPC H05B 3/42

(57) ABSTRACT

Providing a metal heating sleeve pipe and its replacer; the metal heating sleeve pipe includes a metal heating sleeve pipe main body; an inner sunken heating wire slot is coiled at the outer wall of the metal heating sleeve pipe, and an electric heating wire is embedded in the heating wire slot; a plurality of staggered slot holes is longitudinally arranged on the pipe body of the metal heating sleeve pipe main body from one end to the other end; the middle parts of staggered slot holes are provided with replacer expanding opening pillar inserting holes; the replacer for the metal heating sleeve pipe includes a replacer main body which is bilateral symmetrical, a limiting card buckled and fixed at the top part of the replacer main body and used for limiting the cross opening angle of the replacer main body, an open-top screw which is screwed to the left side or the right side of the front end of the replacer main body, and a connector used for connecting and fixing the limiting card with the replacer main body; the replacer main body is provided with left and right replacer expanding pillars, and the open-top screw penetrates through the left part or the right part of the replacer main body. Through the invention, the metal heating sleeve pipe and the heated body are easier and more convenient to mount and dismount.

### CROSS-REFERENCE TO RELATED APPLICATION

This application claims the priority benefit of China application no. 201710522801.8, filed on Jun. 30, 2017. The entirety of the above-mentioned patent application is hereby incorporated by reference herein and made a part of this specification.

### BACKGROUND

### Technical Field of the Present Invention

The invention relates to fittings of a heater for a module, and especially relates to a metal heating sleeve pipe and its replacer.

### Technical Background of the Present Invention

The existing heater for the module or a metal heating sleeve pipe namely is very difficult and trouble to mount and dismount with a heated body or a module pouring opening; for the metal heating sleeve pipe and the module pouring opening must be in interference fit and tightly sleeved together, thus the good heat transfer effect is reached. Thus when the metal heating sleeve pipe and the heated body are required to dismount in installation or repair, it must be very difficult and hard to separate the both; therefore, it is extremely inconvenient to mount and dismount, and a new metal heating sleeve pipe and its replacer are researched and developed to overcome the shortcomings of the prior art.

### SUMMARY OF THE INVENTION

For overcoming the shortcomings of the prior art, the invention aims to provide a metal heating sleeve pipe and its replacer which are easier and more convenient to mount and dismount the metal heating sleeve pipe with the heated body.

The technical scheme for solving the technical problem is: providing a metal heating sleeve pipe, comprises a metal heating sleeve pipe main body; an inner sunken heating wire slot is coiled at the outer wall of the metal heating sleeve pipe, and an electric heating wire is embedded in the heating wire slot; a plurality of staggered slot holes is longitudinally arranged on the pipe body of the metal heating sleeve pipe main body from one end to the other end; the middle part of each of the staggered slot holes is provided with replacer expanding opening pillar inserting holes.

Preferably, two linear long holes are arranged in parallel and oppositely on the pipe body of the metal heating sleeve pipe main body.

Preferably, the replacer expanding opening pillar inserting holes are circular or square holes.

The mating second technical scheme applied to solve its technical problem is: providing a replacer for the metal heating sleeve pipe, which comprises a replacer main body which is bilateral symmetrical, a limiting card buckled and fixed at the top part of the replacer main body and used for limiting the cross opening angle of the replacer main body, an open-top screw which is screwed to the left side or the right side of the front end of the replacer main body, and a connector used for connecting and fixing the limiting card with the replacer main body; the left part and the right part of the replacer main body are connected with an elastic piece; the bottom middle parts of the left and right parts of the replacer main body are symmetrically provided with left and right replacer expanding opening pillars; the left and right replacer expanding opening pillars are combined and the combined body is matched with inserting holes of the right replacer expanding opening pillars of the metal heating sleeve pipe; the open-top screw penetrates through the left part or the right part of the replacer main body.

Preferably, the bottom middle parts of the left and right parts of the replacer main body are symmetrically provided with left and right replacer alignment blocks; the left and right replacer alignment blocks are combined and the combined body is matched with the width of the staggered slot holes of the metal heating sleeve pipe.

Preferably, the left and right replacer expanding opening pillars after being combined are in the shape of circular pillar or square pillar.

The mating third parallel technical scheme applied to solve its technical problem is: providing a replacer of the metal heating sleeve pipe, which comprises a replacing clamp main body which is symmetrical in cross direction, a limiting clip buckled and fixed at the front part of the replacing clamp main body for limiting the cross opening angle of the replacing clamp main body, an open-top frame erected at the back part of the replacing clamp main body, an open-top screw connected to the left side frame wall or the right side frame wall of the open-top frame by thread, a connecting screw used for connecting and fixing the limiting clip with the replacing clamp main body; the left part and the right part of the replacing clamp main body are hinged to each other, and a free pressing spring is arranged between the left part and the right part; the front end middle parts of the left part and the right part of the replacing clamp main body are symmetrically provided with left and right replacing clamp expanding opening pillars; the left and right replacing clamp expanding opening pillars are combined and the combined body is matched with inserting holes of the replacer expanding opening pillars of the metal heating sleeve pipe; the open-top screw penetrates through a left side frame wall or a right side frame wall of the open-top frame.

Preferably, the front end surfaces of the left part and the right part of the replacing clamp main body are corresponding provided with arc surfaces adapted to an outer cylindrical surface of the metal heating sleeve pipe.

Preferably, the left and the right replacing clamp expanding opening pillars after being combined are in the shape of circular pillar or square pillar.

The invention has the beneficial effects that the middle parts of staggered slot holes are provided with replacer expanding opening pillar inserting holes; the bottom middle parts of the left and right parts of the replacer main body are symmetrically provided with left and right replacer expanding opening pillars; the left and right replacer expanding opening pillars are combined and the combined body is matched with inserting holes of the right replacer expanding opening pillars of the metal heating sleeve pipe; the front end middle parts of the left part and the right part of the replacing clamp main body are symmetrically provided with left and right replacing clamp expanding opening pillars; the left and right replacing clamp expanding opening pillars are combined and the combined body is matched with inserting holes of the replacer expanding opening pillars of the metal heating sleeve pipe; multiple staggered slot holes are arranged on the pipe body of the metal heating sleeve pipe main body from one end to the other end longitudinally; thus the metal heating sleeve pipe main body forms an elastic connection in a buckle connection form at the position of multiple staggered slot holes; staggered slot holes can provide elastic expanding or compressing spaces, thus the metal heating sleeve pipe cannot be ruptured; when the corresponding left and right replacers or the clamp expanding opening pillars are plugged in the inserting holes of the replacer expanding opening pillars, and in threaded connection with the open-top screw at the left side or the right side of the front end of the replacer main body, or the open-top screw in threaded connection to the left side frame wall or the right side frame wall of the open-top frame can be screwed in, the left and right replacers or the clamp expanding opening pillars are separated, thus the inserting holes of the expanding opening pillars are jacked towards left and right sides, and the width of the staggered slot holes is forced to expand, so that the inside diameter of the metal heating sleeve pipe is increased; thus the heated body in interference fit before can be easily filled in the metal heating sleeve pipe or taken out; moreover, after filling or taking out, the open-top screw rod is screwed out or the open-top screw is jacked; the width of the staggered slot holes can be elastically returned in place; therefore, the metal heating sleeve pipe is easier and more convenient to mount and dismount with the heated body through the invention.

### BRIEF DESCRIPTION OF THE DRAWINGS

The below will further introduce the invention by combining with the attached figures and embodiment modes.

FIG. 1 is the front structure diagram of the metal heating sleeve pipe.

FIG. 2 is the side structure diagram of the metal heating sleeve pipe.

FIG. 3 is the three-dimensional structure diagram of the metal heating sleeve pipe.

FIG. 4 is the bottom front structure diagram of the replacer.

FIG. 5 is the right side view structure diagram of the replacer.

FIG. 6 is the side view structure diagram of the limiting card.

FIG. 7 is the perspective main view structure diagram of replacing clamp.

### DETAILED DESCRIPTION OF PREFERRED EMBODIMENTS

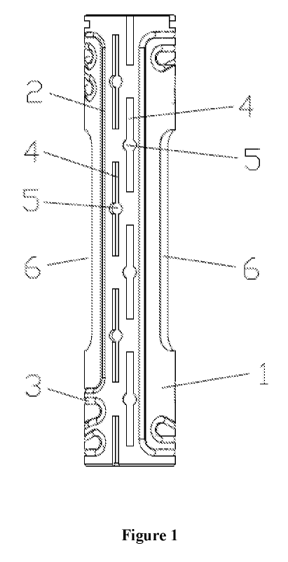

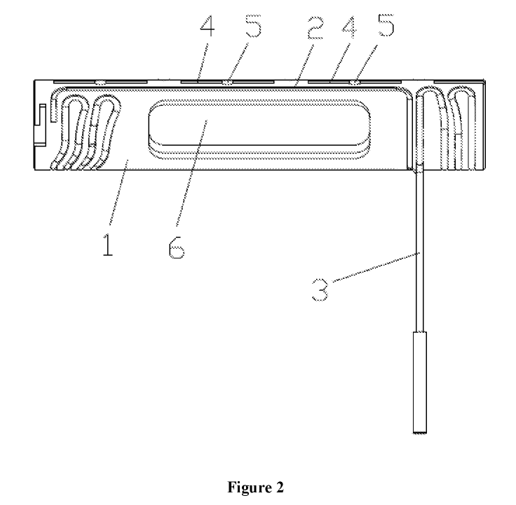

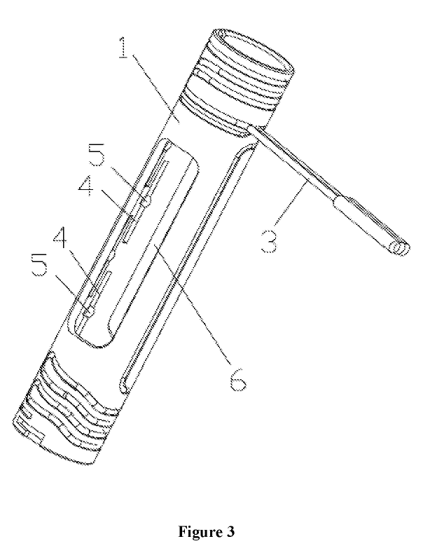

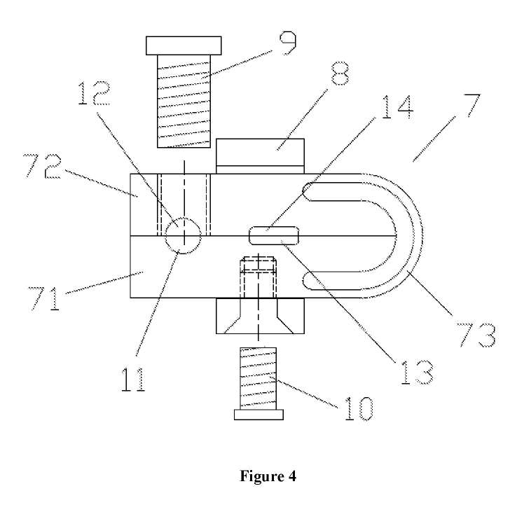

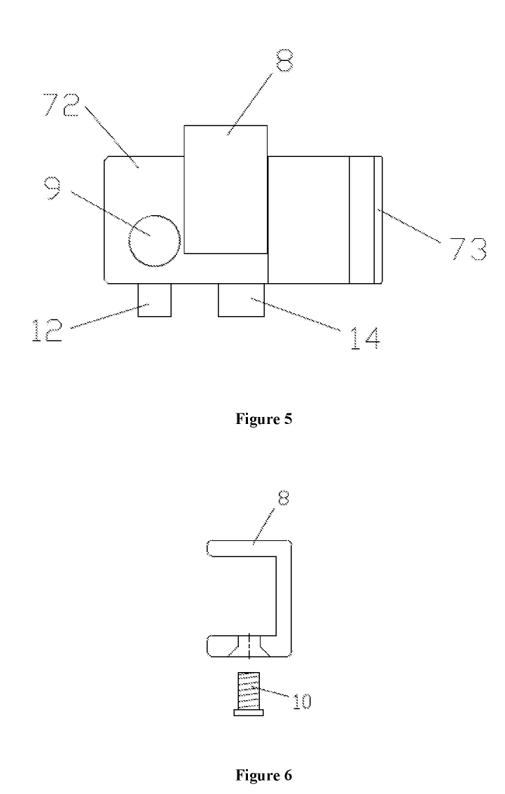

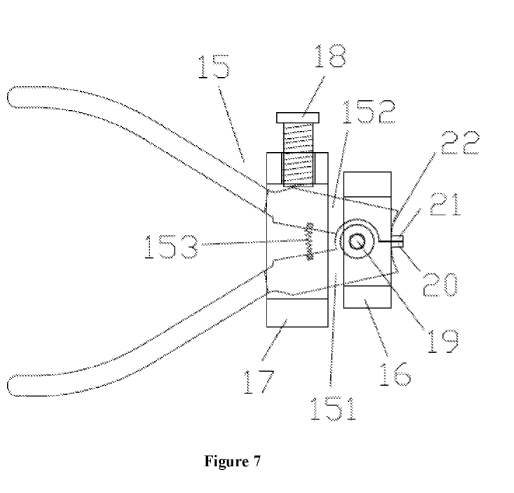

By referring to FIGS. 1-7, the invention comprises three matched technical schemes; the first is a metal heating sleeve pipe, which comprises a metal heating sleeve pipe main body 1; the metal heating sleeve pipe main body is made of copper, aluminum, or other materials with good heat conductivity; the inner sunken heating wire slot 2 is coiled at the outer wall of the metal heating sleeve pipe, and an electric heating wire 3 is embedded in the heating wire slot; a plurality of staggered slot holes 4 is longitudinally arranged on the pipe body of the metal heating sleeve pipe main body from one end to the other end; the middle parts of each of the staggered slot holes are provided with replacer expanding opening pillar inserting holes. Through the plurality of staggered slot holes, the metal heating sleeve pipe main body forms an elastic connection in a buckle connection form at the position of the plurality of staggered slot holes; staggered slot holes can provide elastic expanding or compressing spaces, thus the metal heating sleeve pipe cannot be ruptured; when the corresponding left and right replacers or the clamp expanding opening pillars are plugged in the inserting holes of the replacer expanding opening pillars, and in threaded connection with the open-top screw at the left side or the right side of the front end of the replacer main body, or the open-top screw in threaded connection to the left side frame wall or the right side frame wall of the open-top frame can be screwed in, the left and right replacers or the clamp expanding opening pillars are separated, thus the inserting holes of the expanding opening pillars are jacked towards left and right sides, and the width of the staggered slot holes is forced to expand, so that the inside diameter of the metal heating sleeve pipe is increased; thus the heated body in interference fit before can be easily filled in the metal heating sleeve pipe or taken out; moreover, after filling or taking out, the open-top screw rod is screwed out or the open-top screw is jacked; the width of the staggered slot holes can be elastically returned in place; therefore, the metal heating sleeve pipe is easier and more convenient to mount and dismount with the heated body through the invention.

Preferably, two linear long holes 6 in parallel and opposite are arranged on the pipe body of the metal heating sleeve pipe main body. On the one hand, the linear long holes 6 can be used for placing a spanner to clamp the metal heating sleeve pipe, thus the spanner can rotate the metal heating sleeve pipe conveniently, and the sleeve pipe is further pulled out; on the other hand, the liner long hole forms a hollow position in the middle of the metal heating sleeve pipe, and there is no heating source, thereby avoiding excessive concentrated heating source in the middle part and preventing the stress crack caused by excessively concentrated heat; the inserting holes for the replacer expanding opening pillars are circular or square holes; circular holes are the first-choice; the shape of the expanding opening pillar is corresponding thickened and reinforced; the inserting holes for the expanding opening pillars are located in the middle parts of the staggered slot holes to further have the effect of positioning the expanding opening pillars.

The second technical scheme is that a replacer for the metal heating sleeve pipe according to the previous technical scheme, which comprises a replacer main body 7 which is bilateral symmetrical, a limiting card 8 buckled and fixed at the top part of the replacer main body and used for limiting the cross opening angle of the replacer main body, an open-top screw 9 which is screwed to the left side or the right side of the front end of the replacer main body, and a connector 10 used for connecting and fixing the limiting card with the replacer main body; the left part 71 and the right part 72 of the replacer main body are connected with an elastic piece 73; the bottom middle parts of the left and right parts of the replacer main body are symmetrically provided with left and right replacer expanding opening pillars 11, 12; the left and right replacer expanding opening pillars are combined and the combined body is matched with inserting holes of the right replacer expanding opening pillars of the metal heating sleeve pipe; the open-top screw penetrates through the left part or the right part of the replacer main body. The limiting card 8 is used for preventing the left and right replacer expanding opening pillars 11, 12 from being damaged for the upper part is opened and the lower part is not separated when the staggered slot holes are opened by the left part 71 and the right part 72, and also limiting the cross opening angle of the replacer main body, and preventing the metal heating sleeve pipe from being opened and even ruptured for excessive opening angle and force.

Preferably, the bottom middle parts of the left and right parts of the replacer main body are symmetrically provided with left and right replacer alignment blocks 13, 14; the left and right replacer alignment blocks are combined and the combined body is matched with the width of the staggered slot holes of the metal heating sleeve pipe and used for aligning and placing in the staggered slot holes. The left and right replacer expanding opening pillars after being combined are circular pillars or square pillars, the pillars are not bent or fractured by increasing thickness and enhancing the opening force.

The third technical scheme is that a replacer of the metal heating sleeve pipe of the first scheme, which comprises a replacing clamp main body 15 which is symmetrical in cross direction, a limiting clip 16 buckled and fixed at the front part of the replacing clamp main body for limiting the cross opening angle of the replacing clamp main body, an open-top frame 17 erected at the back part of the replacing clamp main body, an open-top screw 18 connected to the left side frame wall or the right side frame wall of the open-top frame by thread, a connecting screw 19 used for connecting and fixing the limiting clip with the replacing clamp main body; the left part 151 and the right part 152 of the replacing clamp main body are hinged to each other, and a free pressing spring 153 is arranged between the left part 151 and the right part 152; the front end middle parts of the left part and the right part of the replacing clamp main body are symmetrically provided with left and right replacing clamp expanding opening pillars 20, 21; the left and right replacing clamp expanding opening pillars are combined and the combined body is matched with inserting holes of the replacer expanding opening pillars of the metal heating sleeve pipe; the open-top screw penetrates through a left side frame wall or a right side frame wall of the open-top frame. The left and right replacing clamp expanding opening pillars 20, 21 are inserted to the inserting holes of the replacer expanding opening pillars of the metal heating sleeve pipe, and the open-top screw is screwed in by force; surely, the left and right handles of the replacing clamp main body can be held tightly by hands, thus the staggered slot holes of the metal heating sleeve pipe are jacked.

Preferably, the front end surfaces of the left part and the right part of the replacing clamp main body are corresponding arranged to be arc surfaces 22 matched with the outer cylindrical surface of the metal heating sleeve pipe, so as to match with the outer cylinder surface of the metal heating sleeve pipe. The left and right replacing clamp expanding opening pillars after being combined are cylinder or square pillars, thus the pillars are not bent or fractured by increasing thickness and enhancing the opening force.

Besides, the invention is not limited in the above embodiment mode; any embodiment mode reaching the technical effect by the basically same method should belong to the protection range of the invention.

What is claimed is:

1. A metal heating sleeve pipe, comprising:
a metal heating sleeve pipe main body;
a heating wire slot, wherein the heating wire slot is inner sunken and coiled at an outer wall of the metal heating sleeve pipe, and an electric heating wire is embedded in the heating wire slot;
a plurality of staggered slot holes being longitudinally arranged on a pipe body of the metal heating sleeve pipe main body from one end to the other end; and
a replacer expanding opening pillar inserting hole provided in a middle part of each of the staggered slot holes.

2. The metal heating sleeve pipe according to claim 1, wherein two linear long holes are arranged in parallel and oppositely on the pipe body of the metal heating sleeve pipe main body.

3. The metal heating sleeve pipe according to claim 1, wherein the replacer expanding opening pillar inserting hole is circular or square.

4. A replacer for the metal heating sleeve pipe according to claim 1, comprising:
a replacer main body which is bilateral symmetrical,
a limiting card buckled and fixed at a top part of the replacer main body and configured for limiting an opening angle in a bilateral direction of the replacer main body,
an open-top screw which is screwed to a left side or a right side of a front end of the replacer main body, and
a connector configured for connecting and fixing the limiting card with the replacer main body; wherein
a left part and a right part of the replacer main body are connected with an elastic piece;
bottom middle parts of the left part and the right part of the replacer main body are symmetrically provided with left and right replacer expanding opening pillars;
the left and right replacer expanding opening pillars are combined and the combined body is matched with the replacer expanding opening pillar inserting holes of the metal heating sleeve pipe; and
the open-top screw penetrates through the left part or the right part of the replacer main body.

5. The replacer according to claim 4, wherein the bottom middle parts of the left part and the right part of the replacer main body are symmetrically provided with left and right replacer alignment blocks; the left and right replacer alignment blocks are combined and the combined body is matched with a width of the staggered slot holes of the metal heating sleeve pipe.

6. The replacer according to claim 4, wherein the left and right replacer expanding opening pillars after being combined are in a shape of a circular pillar or a square pillar.

7. A replacer of the metal heating sleeve pipe of claim 1, comprising a replacing clamp main body which is symmetrical in a cross direction, a limiting clip buckled and fixed at a front part of the replacing clamp main body configured for limiting a cross opening angle of the replacing clamp main body, an open-top frame erected at a back part of the replacing clamp main body, an open-top screw connected to a left side frame wall or a right side frame wall of the open-top frame by thread, and a connecting screw used for connecting and fixing the limiting clip with the replacing clamp main body; wherein a left part and a right part of the replacing clamp main body are hinged to each other, a free pressing spring is arranged between the left part and the right part, a front end middle parts of the left part and the right part of the replacing clamp main body are symmetrically provided with left and right replacing clamp expanding opening pillars; the left and right replacing clamp expanding opening pillars are combined and the combined body is matched with the replacer expanding opening pillar inserting holes of the metal heating sleeve pipe, and the open-top screw penetrates through the left side frame wall or the right side frame wall of the open-top frame.

8. The replacer according to claim 7, wherein front end surfaces of the left part and the right part of the replacing clamp main body are correspondingly provided with arc surfaces adapted to an outer cylindrical surface of the metal heating sleeve pipe.

9. The replacer according to claim 7, wherein the left and the right replacing clamp expanding opening pillars after being combined are in a shape of a circular pillar or a square pillar.
